(19) United States
(12) Patent Application Publication
(10) Pub. No.: US 2018/0252388 A1
(43) Pub. Date: Sep. 6, 2018

(54) OPTICAL ELEMENT, LIGHTING DEVICE AND LUMINAIRE

(71) Applicant: PHILIPS LIGHTING HOLDING B.V., EINDHOVEN (NL)

(72) Inventor: HENDRIKUS HUBERTUS PETRUS GOMMANS, EINDHOVEN (NL)

(21) Appl. No.: 15/757,661

(22) PCT Filed: Aug. 23, 2016
(86) PCT No.: PCT/EP2016/069885

§ 371 Date: Mar. 6, 2018

(30) Foreign Application Priority Data
Sep. 7, 2015 (EP) 15184054.3

(51) Int. Cl. F21V 5/04; G02B 19/00; G02B 3/08

(52) U.S. Cl. CPC F21V 5/045; G02B 19/0028; F21Y 2115/10; G02B 3/08; G02B 19/0061

(57) ABSTRACT

Disclosed is an optical element (100) for creating a collimated beam from a luminance distribution generated by a light source (200) placed at a defined position at the optical axis (105) of the optical element, the optical element comprising an inner zone (110) centered on said optical axis, the inner zone having a plurality of inner zone regions for generating a first plurality of partially overlapping images of said luminance distribution at a defined distance from the lens, the first plurality of partially overlapping images defining a first superimposed image having a first image width at the defined distance; and an outer zone (130) around said inner zone, the outer zone having a second plurality of outer zone regions for generating a second plurality of partially overlapping images of said luminance distribution at the defmed distance, the second plurality of partially overlapping images defining a second superimposed image having an second image width smaller than the first image width at the defmed distance, the second superimposed image being superimposed on the first superimposed image at the defmed distance. Also disclosed is a lighting device including the optical element and a luminaire including the lighting device.

### FIELD OF THE INVENTION

The present invention relates to an optical element for creating a collimated beam of a luminance distribution generated by a light source.

The present invention further relates to a lighting device including such an optical element.

The present invention yet further relates to a luminaire including such a lighting device.

### BACKGROUND OF THE INVENTION

White light sources are increasingly realized using solid state lighting devices, that is, light emitting diodes (LEDs) due to their superior lifetime and energy efficiency compared to e.g. halogen and incandescent light sources. The LEDs are typically integrated in a package that further includes one or more phosphors to convert (part of) the emission spectrum of the LEDs in order to create a luminous output of a desired color temperature. Due to the spatial separation of the LEDs and phosphor(s), the luminous output of such a package tends to exhibit color separation, that is, a region of unconverted light generated by the LEDs and a region of light converted by the one or more phosphors. Such color separation is considered unacceptable from an aesthetic perspective.

Such color separation may be rectified using a diffuser, which essentially randomly scatters, i.e. increases the etendue of, the light originating from the package to achieve effective color mixing. This is particularly suitable for applications in which diffuse light is acceptable, but is less suited for application domains in which a lighting device is required to produce light having limited etendue, i.e. more collimated light, e.g. spot light applications.

Such more focused light output may be achieved using a collimator for example. However, a collimator is typically unsuitable to rectify color separation in the luminous output of a LED package as the collimator creates an image of the light source, e.g. the LED package, in the far field when the light source is placed in the focal point of the collimator. This is sometimes referred to as ‘color over position’. Therefore, in application domains where collimation is required, multiple optical elements, e.g. a collimator combined with a diffusing foil, are typically integrated in the lighting device to achieve beam shaping and color mixing respectively.

A drawback of such an approach is that the integration of multiple optical elements in the lighting device increases manufacturing complexity and cost of the lighting device. Hence, there exists a need to achieve color-mixed collimated light using a single optical component.

### SUMMARY OF THE INVENTION

The present invention seeks to provide an optical element capable of generating a collimated beam with effective colour mixing within said output.

The present invention further seeks to provide a lighting device including such an optical element.

The present invention yet further seeks to provide a luminaire including such a lighting device.

According to an aspect, there is provided an optical element for creating a collimated beam at a defined finite distance from the optical element of a luminance distribution generated by a light source placed at a defined position at the optical axis of the optical element, the optical element comprising an inner zone having a plurality of inner zone regions for generating a first plurality of partially overlapping images of said luminance distribution at the defined finite distance, the first plurality of partially overlapping images defining a first superimposed image having a first image width at the defined finite distance; and an outer zone around said inner zone, the outer zone having a second plurality of outer zone regions for generating a second plurality of partially overlapping images of said luminance distribution at the defined finite distance, the second plurality of partially overlapping images defining a second superimposed image having a second image width smaller than the first image width at the defined distance, the second superimposed image being superimposed on the first superimposed image at the defined distance.

The present invention is based on the insight that different regions of a (circular) optical element typically image different views of the luminance distribution of a light source, with the more peripheral regions of the optical element, i.e. the outer regions, imaging a tilted view of the luminance distribution , whereas the more central regions of the optical element typically image the front view of the luminance distribution due to the angular relationship between these central regions and the light source such that the more central regions may define the beam width of the formed collimated beam.

Therefore, the central region is particularly suited to define the overall beam angle of the image created by the optical element at a defined distance of the optical element, e.g. a distance of about 1-1.5 m in case of the optical element being included in a spotlight for downlighting applications. The partial overlap or stitching of the individual images produced by the zone regions further ensures image blurring at the defined finite distance, whereas the superposition of superimposed created by the respective zone regions onto each other and within the first image portion at a defined distance from the optical element, e.g. at a point in the far field, further image blurring is achieved in the overall image at that point without the loss of collimation. Such image blurring can compensate for color separation in the luminance distribution, for instance in case of a LED package generating spatially separated colors over its finite width due to the spatial separation of the one or more phosphors from the one or more LEDs.

The optical element may have any suitable shape, e.g. circular, square, oblong, or even non-symmetrical shapes although a circular shape is particularly advantageous in terms of ease of design and manufacture.

In a particularly advantageous embodiment, the inner zone is arranged to create a first superimposed image having a constant luminance across the first image width from a Lambertian luminance distribution, with the first image width optionally defining the beam width of the collimated beam. Preferably, the outer zone is arranged to create a second superimposed image having a variable luminance across the second beam width from the Lambertian luminance distribution, wherein the variable luminance has a maximum value optionally coinciding with the optical axis at the defined distance. In this embodiment, a target illuminance may be approximated by the optical element by virtue of different zones generating different portions of the target illuminance that are superimposed on each other to approximate the overall target illuminance. More specifically, the target illuminance is partitioned in an axially symmetrical manner, e.g. horizontally sliced, with the inner zone(s) generating the lower portion(s) of the target illuminance and the outer zone(s) generating the upper portion(s) of the target illuminance.

The target illuminance may be a Gaussian distribution in which case the variable illuminance exhibits a Gaussian distribution across the second image width. More generally, the variable illuminance of the second superimposed image typically defines the contrast in the beam produced by the optical element. The second superimposed image may be centered on the first superimposed image to create a beam having its maximum contrast in the centre of the beam, e.g. to create a Gaussian light distribution. Alternatively, the second superimposed image may envelope a dark region, e.g. may be an annular image in case of a circular optical element, with the dark region centered on the first second superimposed image to create a beam having its maximum contrast or intensity in a peripheral region of the beam.

In an embodiment, the inner zone is a refractive zone and/or the outer zone is a total internal reflection zone in order to optimize light collection efficiency of the optical element. Each outer zone regions may comprise a reflecting facet, the facets combining to implement the second plurality of partially overlapping images. Furthermore, at least some of the inner zone regions may comprise a facet. This is for instance a particularly suitable embodiment for generating a Gaussian distribution with an optical element having a larger diameter than the maximum dimension of a light source producing a Lambertian distribution, e.g. a LED package. For different applications, other design choices may be more appropriate, e.g. a reflective inner zone such as a totally internally reflective inner zone and/or a refractive outer zone.

In order to create the partial overlap in the respective images generated by the zone regions of a particular zone, the zone regions may have different focal points on the optical axis. For example, the focal points may be a function of the radial position of the zone regions, i.e. may be varied as a function of the radial position of the zone in the optical element in order to create the image stitching.

The optical element may further comprise at least one intermediate zone in between the inner zone and the outer zone, the at least one intermediate zone comprising a plurality of further zone regions for generating a further plurality of partially overlapping images of said illumination pattern at the defined finite distance, the further plurality of partially overlapping images defining a further superimposed image having a further image width at the defined distance, the further image width being smaller than the image width of each zone at a smaller radial position of the optical element and larger than the image width of each zone at a larger radial position of the optical element, the further superimposed image being superimposed on the first superimposed image at the defined distance. The inclusion of additional zones for image blurring allows for the provision of an optical element that has a diameter that is (substantially) larger than the maximum dimension of a light emission surface of the light source whilst retaining the desirable distribution profile and color mixing properties of the optical element. It is noted that the number of zones to be included in the optical element design is in principle arbitrary although an increased number of included zones will improve the approximation of the target luminous profile and facilitate the exclusion of a zone from an optical element design if the optical element dimensions need altering, e.g. for a different lighting device having a different size, without requiring a total redesign of the optical element.

The optical element may have a major surface comprising a stepped profile in which each step delineates one of said respective zones. In order words, the lens may exhibit clearly discontinuous zones, each implementing a particular optical function.

According to another aspect, there is provided a lighting device comprising the optical element of any of the above embodiments and a light source placed on the optical axis of the optical element and arranged to direct its light distribution towards the optical element, the optical element optionally having a diameter that is larger than a maximum dimension of a light emission surface of the light source. Such a lighting device can produce collimated light having improved uniformity in color output using a single optical element only.

The light source preferably comprises a light emitting diode package including at least one light emitting diode and a phosphor for converting a light wavelength generated by the at least one light emitting diode, as for such a light source the lighting device can produce a luminous output with aesthetically acceptable levels of color separation.

According to yet another aspect, there is provided a luminaire comprising any aforementioned embodiment of the lighting device. Such a luminaire benefits from being capable of producing a collimated luminous output, e.g. a light spot, with aesthetically acceptable levels of color separation. Such a luminaire for instance may be a holder of the lighting device, e.g. a ceiling-mounted spot light, a wall-mounted spot light, an armature, a pendant, an electrical device including the lighting device, e.g. an extraction hood over a cooker, and so on.

### BRIEF DESCRIPTION OF THE DRAWINGS

Embodiments of the invention are described in more detail and by way of non-limiting examples with reference to the accompanying drawings, wherein:

FIG. 1 schematically depicts an optical arrangement including a small Lambertian light source facing an annular optical element;

FIG. 2 is a graph depicting the geometrical configuration factor and its radial derivative as a function of radial position for the optical arrangement of FIG. 1;

FIG. 3 is a graph depicting the geometrical configuration factor and its radial derivative as a function of the field angle for the optical arrangement of FIG. 1;

FIG. 4 schematically depicts an optical arrangement including an extended Lambertian light source facing an annular optical element;

FIG. 5 is a graph depicting the cone angle of the annular optical element of FIG. 4 as a function of radial distance;

FIG. 6 is a graph depicting a reciprocal area illuminated by an optical element of FIG. 4 as a function of radial distance;

FIG. 7 schematically depicts beamlet generation at different radial positions in the optical arrangement of FIG. 4;

FIG. 8 depicts a central beamlet collected at 1.4 m distance from a total internal reflection Fresnel lens imaging a LED package placed at 5 mm from the lens;

FIG. 9 depicts a peripheral beamlet collected at 1.4 m distance from a total internal reflection Fresnel lens imaging a LED package placed at 5 mm from the lens;

FIG. 10 schematically depicts a top view of an optical element according to an example embodiment;

FIG. 11 schematically depicts a cross-sectional view of an optical element according to an example embodiment;

FIG. 12 schematically depicts a cross-sectional view of a lighting device according to an example embodiment;

FIG. 13 schematically depicts the approximation of a target illuminance profile by an optical element according to an embodiment;

FIG. 14 schematically depicts required flux distributions for the respective zones of an optical element according to an embodiment in order to approximate the target illuminance profile of FIG. 13;

FIG. 15 depicts the beam deflection angles for the various zones in the optical element of FIG. 11 as a function of radial position;

FIG. 16 schematically depicts the beam angles generated by the various zones of the optical element in the lighting device of FIG. 12;

FIG. 17 schematically depicts the mapping of the required flux distributions of FIG. 14 onto various zones of the optical element in the lighting device of FIG. 12;

FIG. 18 depicts an image generated by the optical element in the lighting device of FIG. 12 and collected at 1.4 m distance therefrom; and

FIG. 19 depicts a simulated intensity profile for an optical element according to an example embodiment.

### DETAILED DESCRIPTION OF THE EMBODIMENTS

It should be understood that the Figures are merely schematic and are not drawn to scale. It should also be understood that the same reference numerals are used throughout the Figures to indicate the same or similar parts.

For a better understanding of aspects of the present invention, a theoretical evaluation of imaging Lambertian light sources with an annular optical element such as an annular facet of a total internal reflection (TIR) Fresnel lens will be provided. The following units will be used:
Incident Flux: Φᵣ [1m]

Radiant Flux: Φᵣ [1m]

Luminance: L=Φᵢ/(ΩAᵣ) [1m sr⁻¹ m⁻²]

Luminous intensity: I=Φᵢ/ω [cd=1m sr⁻¹]

Illuminance: E=Φᵢ/Aᵢ [1m m⁻²]

Projected solid angle: Ω [sr]

Solid angle: ω [sr]

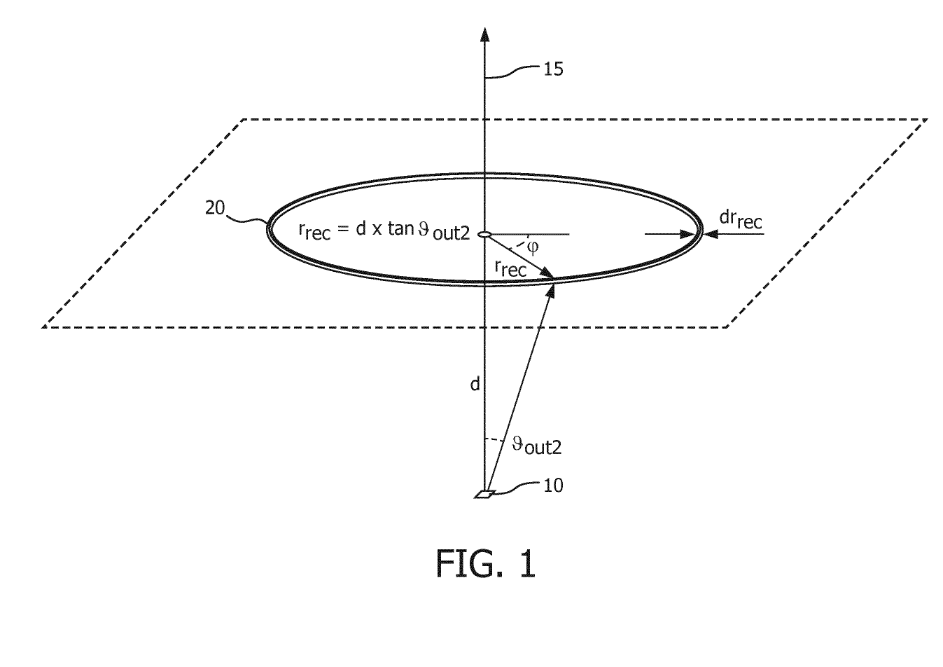

For linking a small (illuminating) area to an extended (illuminated) area or image, a geometrical configuration factor (GCF): C=Ω/π is used. FIG. 1 schematically depicts such a small Lambertian light source 10 placed on the optical axis 15 of an annular optical element arranged to create a light source image 20 at a radial distance r_{rec} from the optical axis 15 with image width drrec at a distance d from this light source 10. The distance d is typically a target distance at which a desired optical performance is to be generated by the optical element, e.g. a desired degree of collimation.

The GCF is the lumen fraction that is transferred from the source or radiant flux, Φᵣ, to the illuminated area or incident flux, Φᵢ. For a small Lambertian source (approaching a point source) illuminating an extended rotational symmetric surface, the following equation is obtained:

$$C = \frac{{r}_{rec}^{2}}{{d}^{2} + {r}_{rec}^{2}} = {sin}^{2} υ with tan υ = \frac{{r}_{rec}}{d}$$

This can be derived by determining the lumen fraction into the solid angle with half angle ϑ:

$${Φ}_{i} = \int {\int }_{{S}_{h}} I ( ϑ , ϕ ) d ω = {\int }_{0}^{2 π} {\int }_{0}^{ϑ} I ( ϑ , ϕ ) sin ϑ d ϑ d ϕ = 2 π {l}_{0} {\int }_{0}^{ϑ} cos ϑ sin ϑ d ϑ = π {I}_{0} {sin}^{2} ϑ {\vert}_{0}^{ϑ}$$

where a Lambertian light distribution I(ϑ, φ)=I(ϑ)=I₀·cosϑ is typically assumed for a LED source over the whole angular range of ϑ=[0, π/2].

By taking the derivative to its radial coordinate the lumen fraction transferred to each annular image area of size 2πr_{rec}·dr_{rec} is obtained:

$$\frac{dC}{{dr}_{rec}} = \frac{2 {r}_{rec}}{{d}^{2}} \frac{1}{{( \frac{{r}_{rec}^{2}}{{d}^{2}} + 1 )}^{2}} = \frac{2 {r}_{rec}}{{d}^{2}} {cos}^{4} υ [ {m}^{- 1} ]$$

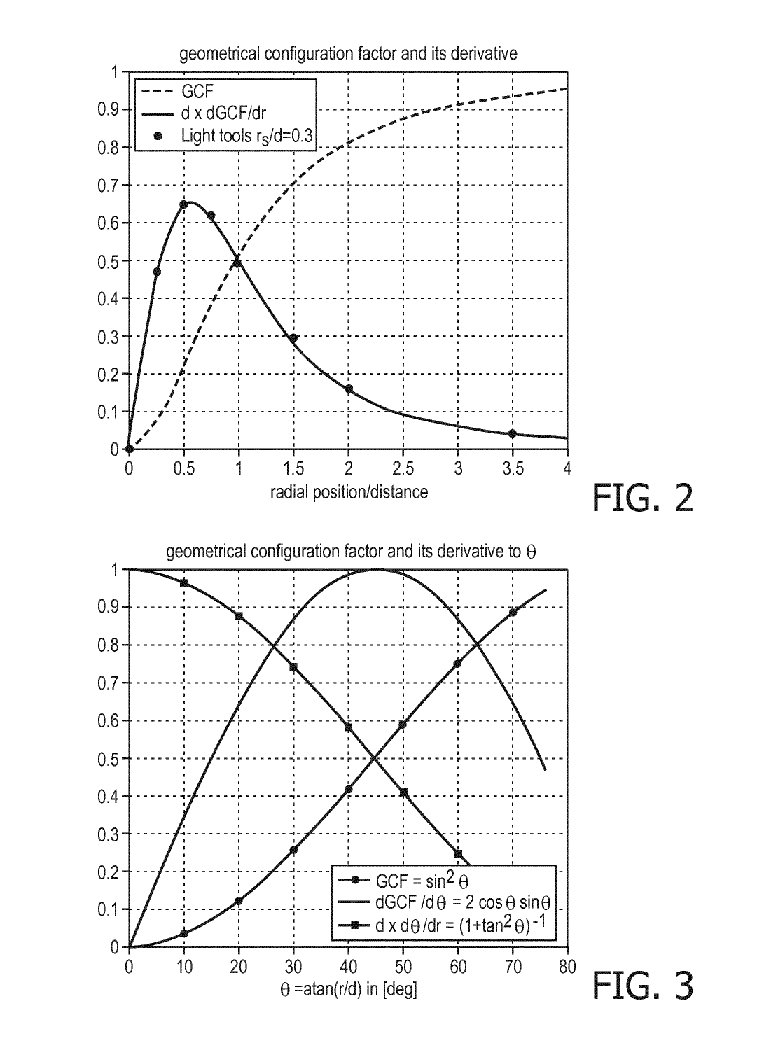

FIG. 2 is a plot of the GCF for the arrangement of FIG. 1 and its derivative to the radial position of the annular optical element 20. A model was built using the Lighttools illumination design software to determine the derivative for a light source with width rs=1.5 mm and d=5 mm and the derivative curve fitted to discrete simulated values of the derivative with this model, as indicated by the dots in FIG. 2. FIG. 3 is a plot of the GCF for the arrangement of FIG. 1 and its derivative to the field angle of the annular optical element as a function ϑ (r=r_{rec}):

$$\frac{dC}{d ϑ} = 2 sin ϑ cos ϑ = \frac{2 r}{d} \frac{1}{( \frac{{r}^{2}}{{d}^{2}} + 1 )} = \frac{2 r}{d} {cos}^{2} ϑ with$$

$$d ϑ = dr \frac{1}{d} \frac{1}{( \frac{{r}^{2}}{{d}^{2}} + 1 )} = \frac{{cos}^{2} ϑ}{d} dr$$

dr_{rec}/d was chosen (arbitrarily) at 0.02. FIG. 2 shows a linear term in ‘r’ and an inverse fourth power, r⁻⁴ (due to cos⁴), which represents the term for (increasing) circle area and the well-known approximate cosine-fourth law for illumination of a Lambertian source, respectively. The factor d⁻² accounts for the inverse-square law stating that the intensity is inversely proportional to the square of the distance from the source 10.

FIG. 3 shows that as the off-axis distance between illuminating and illuminated area increases with cos ϑ, the applicable inverse square law results in a cos² term in dϑ/dr_{rec}. The graphs in FIGS. 2 and 3 for instance may be used to estimate the lumen fraction of a small Lambertian source that can be deflected with refraction and with (total internal) reflection with an annular optical element having a width dr at a certain radial distance from its optical axis 15. It will further be clear that reducing the distance between collecting surface and source, d, will increase the collected lumen fraction.

However, at some distance the point source approximation renders inaccurate as most light sources cannot be accurately approximated by a small Lambertian source due to the dimensions of the light source. For example, a LED package can have a maximum dimension (sometimes referred to as diameter even when the package may not be circular, e.g. a diagonal of a rectangle), of several millimeters, in which case the small Lambertian light source is a poor approximation.

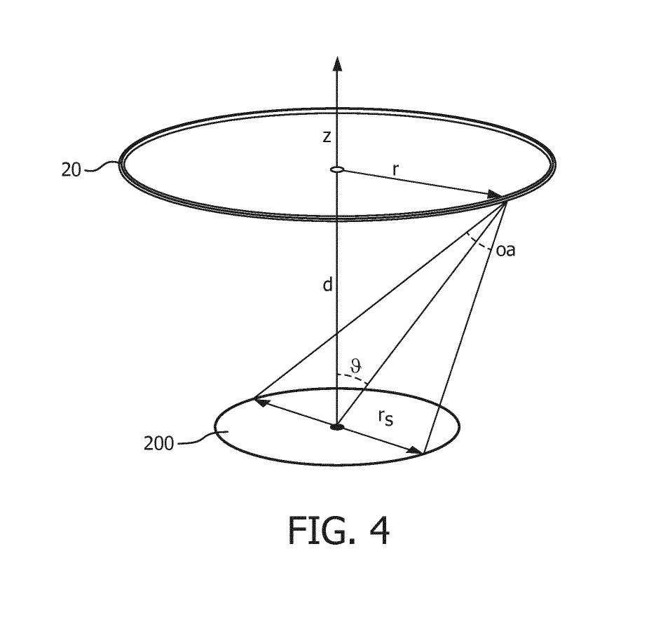

FIG. 4 schematically depicts an optical arrangement comprising such an extended Lambertian source, e.g. a LED package 200 having a radius rₛ and cone angle oa relative to the annular optical element 20, e.g. a facet of a TIR Fresnel lens. As will be apparent, the cone angle, oa, for facets positioned near to the optical axis is much larger than for facets further from the optical axis.

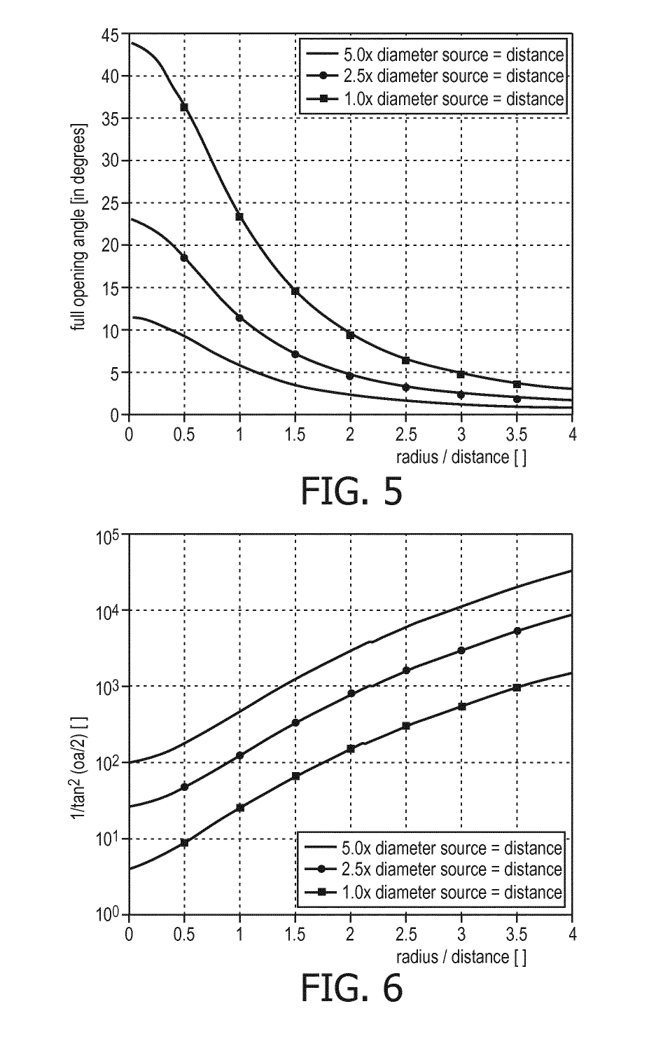

The cone angles of the annular optical element as a function of radial position were calculated as a function of several extended light source diameters using:

$$oa = {tan}^{- 1} ( \frac{{r}_{s} + r}{d} ) + {tan}^{- 1} ( \frac{{r}_{s} - r}{d} ) for r \leq {r}_{s} ;$$

$$oa = {tan}^{- 1} ( \frac{{r}_{s} + r}{d} ) - {tan}^{- 1} ( \frac{r - {r}_{s}}{d} ) for r > {r}_{s}$$

where oa is the full cone angle and rₛ is the extended light source radius. The results are shown in FIG. 5, which clearly demonstrate that due to the extended source geometry of the extended light source the degree of collimation becomes limited, especially near the optical axis 15. This has been more clearly visualized in FIG. 6, which is a plot depicting the relationship 1/tan²(oa/2), which is a measure for the reciprocal area 20 illuminated by a facet as a function of radial position. This shows how an extended light source with radius rs comparable to the distance between optical element and source, d, limits the degree of collimation as a function of radial position of the annular optical element.

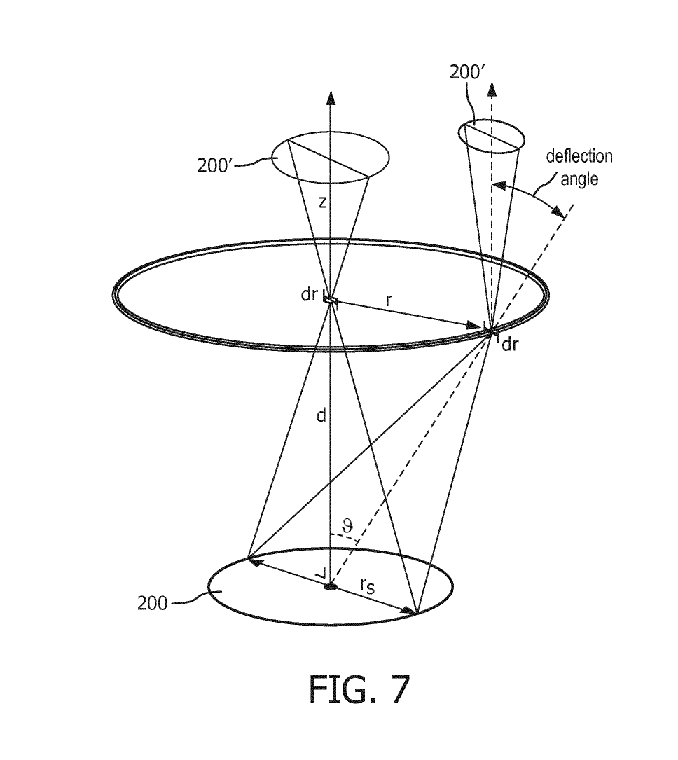

For radial positions close to the optical axis 15, beamlets are deflected parallel to the optical axis to create an (inverted) image of the light source. For radial positions located further from the optical axis the cone angle of the beamlet, oa, reduces and as a result the degree of collimation increases. Clearly, the projected source image from these facets reduces in size as well, and will be spatially separated from the image produced by more central facets. This is schematically depicted in FIG. 7, showing the spatially separated images 200′ of the extended light source 200 generated by annular optical elements in different radial positions of a lens, i.e. producing images at a different rrec.

An extended light source 200 may produce a luminance distribution including spatial color separation. This for instance can be the case with LED packages including one or more phosphors that output light at the wavelengths produced by the one or more LEDs in the package and light at the wavelengths converted by the one or more phosphors, where the spatial arrangement of the phosphors, e.g. at the periphery at the package, can cause the extended light source to produce light of a first spectral composition in its centre and light of a second spectral composition in its periphery, e.g. blue light or cool white light in its centre, and warm white light in its periphery. For images 200′ produced by facets in different radial positions, such images tend to exhibit a peak intensity relating to different regions of the extended light source 200 resulting from the radial dependency to the cone angle. This is particularly the case where an optical element such as a collimating TIR Fresnel lens has a diameter exceeding the maximum dimension of the extended light source 200. This can be perceived as the lighting device including the extended light source 200 and the optical element producing a luminous output with unacceptably high spatial color separation from an aesthetic perspective.

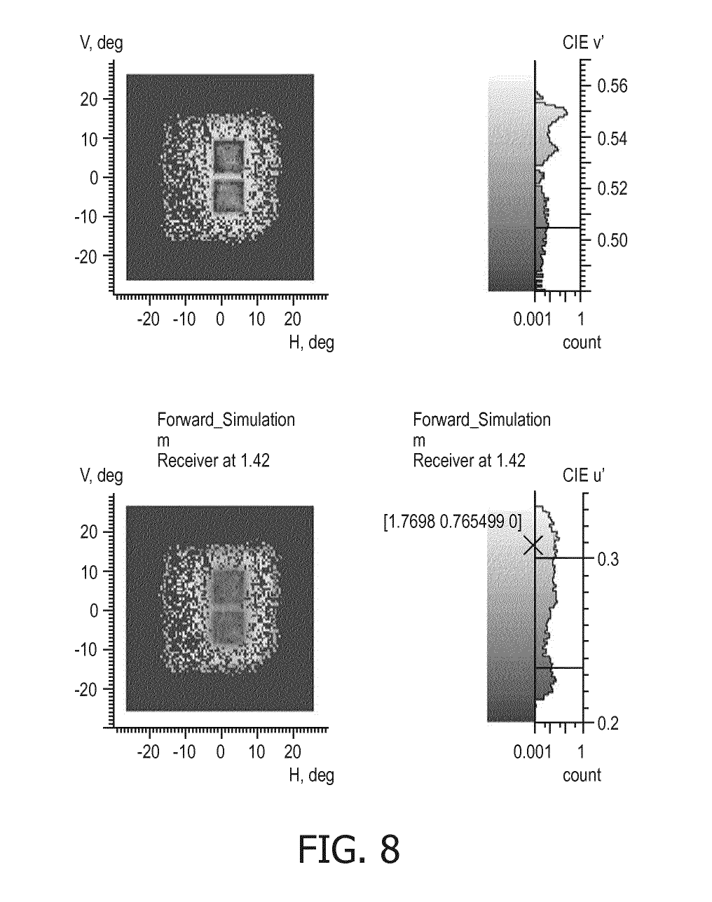

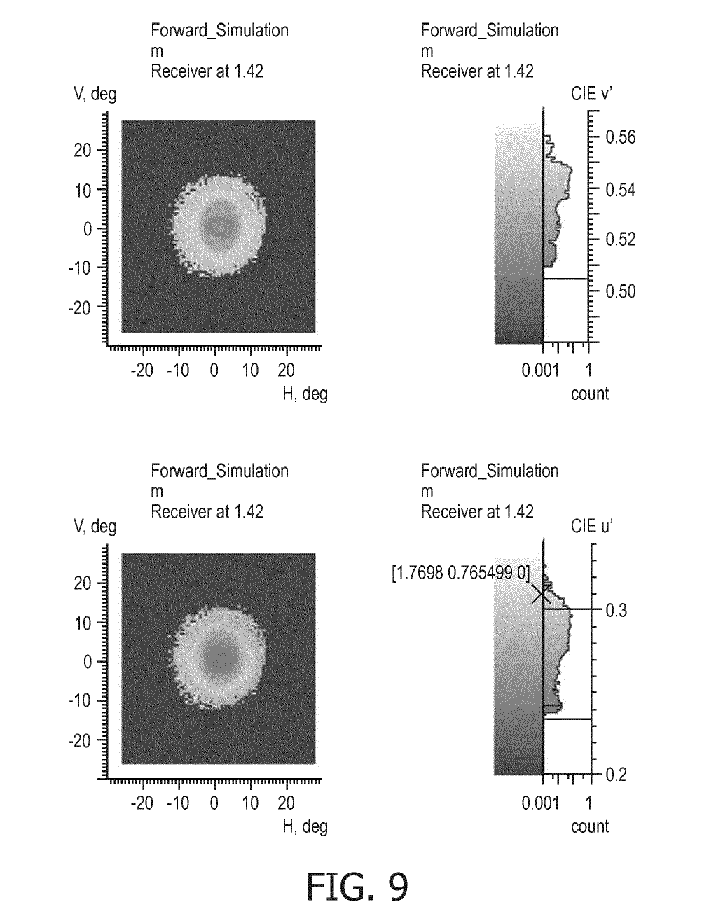

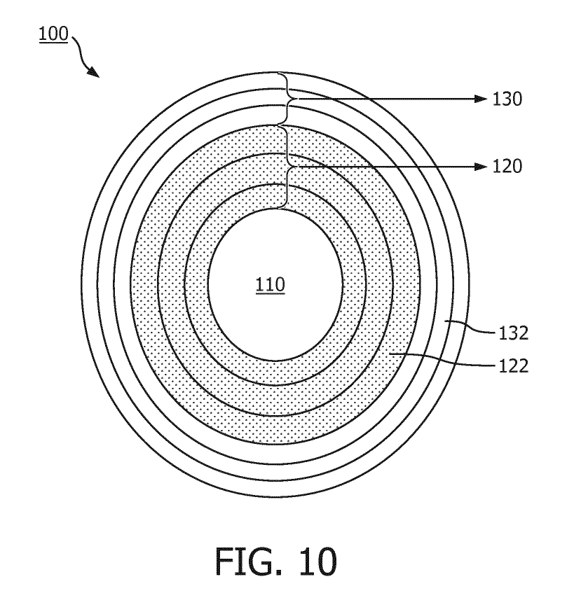

This is shown in FIGS. 8 and 9, which show CIE v′ (top) and CIE u′ (bottom) images of a Nichia 3030 LED package as manufactured by the Nichia corporation generated by a TIR Fresnel lens of 10 mm radius positioned at 5 mm from the LED source and the spectral composition of these images. FIG. 8 depicts the image produced by a facet at the optical axis and FIG. 9 depicts the image produced by a facet at 5.9 mm from the optical axis. The far-field images were collected by a receiver at the optical axis at 1.4 m distance from the LED source.

The beamlet collected at the optical axis gives an image with high image quality, while the image collected from the radial distance of 5.9 mm from the optical axis is collected via total internal reflection and as a result provides an image that has experienced a revolution around the optical axis. The difference in beam widths of the individual beamlets is due to the light collecting angle of the lens as previously explained: At the optical axis the LED surface area is fully collected, while at radial position 5.9 mm the light is collected under an angle (atan 5.9/5=50) and as a result the collection angle is reduced. What is also immediately clear is that both images contain a cold white central area (corresponding to the blue die) and warm white peripheral area that corresponds to the phosphor emission in the LED package, although the relative intensities of these colour components differ between images.

Therefore, in order to generate a light beam with high color homogeneity, a degree of color mixing needs to be implemented to reduce this color separation. Moreover, in many application domains a Lambertian distribution or profile is undesirable, and conversion into a different light distribution may be required, e.g. a Gaussian profile.

The present invention is based on the insight that an optical element may be formed from a number of regions or zones that are adapted to generate a particular portion of the desired distribution, wherein within each portion a plurality of light source images are generated that are projected towards a target such that the respective source images at least partially overlap. This introduces image blurring into the overall image produced by the region or zone, whilst a high degree of collimation still can be achieved. The zones are typically defined by a transfer function that converts an incident light distribution such as a

Lambertian profile into a target profile such as a Gaussian profile. The target Gaussian profile is partitioned in an axially symmetrical manner, e.g. by forming horizontal partitions or partitions at least comprising a horizontal component, wherein each region or zone of the optical element is responsible for approximating such a partition. The images produced by the respective regions of zones of the optical element are superimposed at the target to obtain a desired collimation at the target in which the overlap in beamlet images has caused substantial blurring of the light source image, resulting in less pronounced color separation in the collimated beam produced at the target.

Importantly, as explained with the aid of FIG. 7, the central regions of the optical element produce larger light source images as a result of the larger cone angles and therefore require a larger image profile width in order to effectively superimpose the beamlet images produced at different radial positions within such a central region. For this reason, where a target illumination profile, e.g. a Gaussian profile, is partitioned into a number of horizontal slices to be approximated by the respective regions or zones of the optical element, the slices in a direction from the bottom to the top portion of the target profile are approximated by zones with decreasing cone angles, i.e. in a radially outward direction, such that zones with larger cone angles approximate wider portions or slices of the target illumination profile to facilitate the effective superposition of the larger beamlet images at the target location. In an embodiment, the innermost zone of the optical device generates an image comprising the superimposed beamlet images, which superimposed image defines the beam width of a collimated beam formed by the optical element.

It is noted that such axially symmetrical, e.g. horizontal partitioning is counterintuitive as usually vertical partitioning of the target illumination profile is applied in optical element designs, e.g. lens designs, with outer regions of the optical element producing the outer wings of the target illumination profile, but as can be understood from FIG. 7, such vertical partitioning leads to clear image forming at the target location, e.g. clear visualization of the light source such as a LED package, which often is aesthetically unacceptable.

Aspects of the present invention provide an optical element in which a high degree of collimation of a light source can be achieved at a defined (finite) distance from the optical element if the light source is placed at the correct distance from the optical element but that produces a blurred image of the light source by superposition of beamlet images generated at different radial positions of the optical element. Such superposition preferably is partial superposition, that is, a first region of a first beamlet image may be superimposed on a second region of a second beamlet image, in order to improve colour mixing in the overall image composed of the beamlet images generated by the zone of the optical element. For example, in case of beamlet images imaging a spatially separated colour spectrum generated by a light source such as a LED package, a first spectral region of a first beamlet image may be superimposed on a second spectral region of a second beamlet image to compensate for such spatial colour separation. In this manner, a blue or cold white part of a spectrum in a first beamlet image may be superimposed on a warm white part of a spectrum of a second beamlet image to improve the colour mixing in the overall image produced by the optical element.

To this end, the optical element typically comprises at least two imaging zones; an inner zone for creating a collimated image portion (a first superimposed image) of the light source and an annular outer zone around the inner zone the respective image portions are preferably partially superimposed on each other, e.g. around the optical axis, at a defined distance from the optical elements to form a second superimposed image within the first superimposed image at the defined distance, for example in the far-field, e.g. at 1 meter or further from the light source.

In other words, the overall collimation of the optical element may be dominated by the central zone, as this zone can image the entire light source, whereas the more peripheral zones are arranged to project their superimposed images comprised of the overlapping beamlet images onto the image(s) generated by the central zone(s), thereby creating a collimated blurred image having improved color homogeneity and a desired luminous profile, e.g. a Gaussian illumination profile.

The various zones of the optical element may generate different illumination profiles in some embodiments. For example, an inner zone of the optical element may generate a constant illuminance profile, i.e. in which the flux divided by a zone surface area is constant in order to yield zero contrast within the superimposed image produced by the zone, as it forms the base (lower slice) of the target profile and as such does not require to adopt the overall shape of the target profile, whereas an outer zone of the optical element may be designed to generate a target profile illuminance as it forms the peak (upper slice) of the target profile and as such should closely resemble the desired profile.

The variable illuminance portion typically defines the contrast in the target distribution, i.e. the collimated beam, to be formed by the optical element. The variable illuminance portion may form a continuous second superimposed image that is centered on the first superimposed image, e.g. to form a distribution having its peak intensity in the collimated beam centre, such as a Gaussian distribution, but this is not essential. The second superimposed image for instance may envelope a dark region, e.g. have an annular shape in case of a circular optical element, in which case the region(s) of maximum intensity in the collimated beam may be in its periphery.

In a preferred embodiment, an optical element according to the present invention comprises at least one constant illuminance zone, which typically is the innermost zone of the optical element for reasons that will be explained in more detail below. The inner zone may be a reflective zone, e.g. a TIR zone, or a refractive zone. The outer zone may be a reflective zone, e.g. a TIR zone, or a refractive zone. In an embodiment, the inner zone is a refractive zone and the outer zone is a TIR zone by way of non-limiting example. Each zone may be implemented by a plurality of refracting or reflecting annular facets, e.g. TIR facets, that combine to create the plurality of superimposed beamlet images, i.e. images of (part of) the luminance distribution generated from a light source.

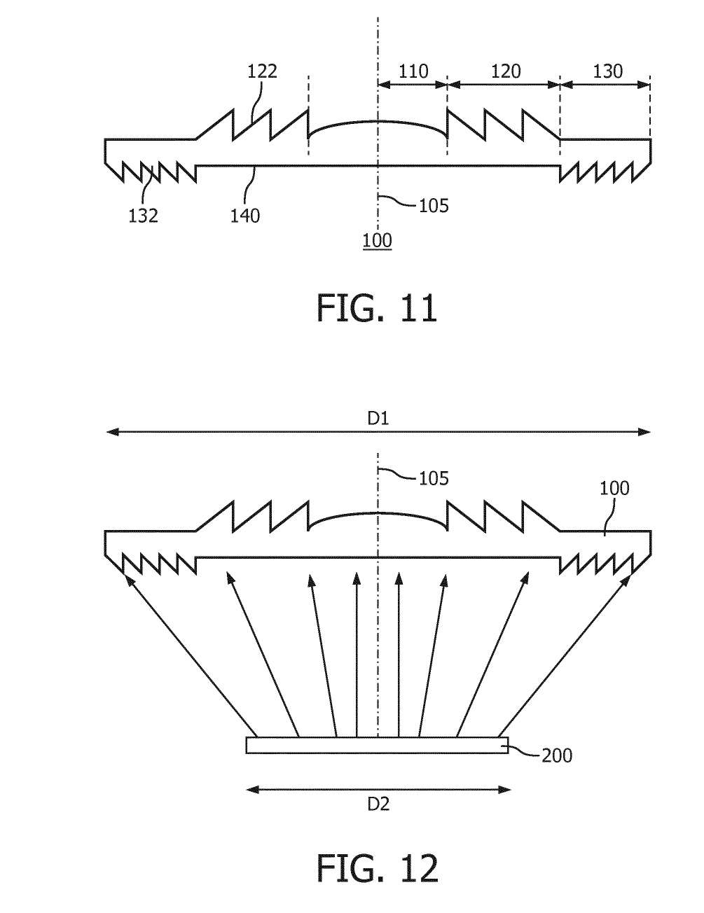

FIG. 10 schematically depicts a top view and FIG. 11 schematically depicts a cross-section of an example embodiment of such an optical element 100 comprising a central refractive zone 110 and a plurality of annular zones including a first annular zone 120 around the central refractive zone 110 comprising a plurality of facets 122 and a second annular zone 130 around the first annular zone 120 comprising a plurality of facets 132. The facets of the respective annular zones are arranged to create a blurred image at a defined distance from the optical element 100 as explained above.

The facets of at least some of the zones of the optical element 100 will be reflective facets, e.g. total internal reflection facets, typically the facets of at least the outermost zone (here zone 130) of the optical element 100 to maximize the deflected lumen fraction by the facets as explained above. The central zone 110 may be a spherical zone or may comprise annular facets, optionally in combination with a spherical central portion. The discontinuation of the refractive zones may be correlated to the maximum dimension of the light source to be imaged by the optical element 100. For example, a zone boundary in terms of radial distance from the optical axis 105 of the optical element 100 may be chosen to coincide with the maximum dimension of the light source, with the one or more zones within this boundary being refractive zones and the one or more zones outside this boundary being total internal reflection zones for reasons of maximizing optical efficiency of the optical element 100. The number of facets in a particular zone is not particularly limited; any suitable number of facets may be chosen. The miniaturization of the facets, leading to a larger number of smaller facets, for instance may be desirable in applications where the overall height of the optical element 100 should be limited, e.g. when used in a solid state lighting device having a predefined form factor.

It is reiterated that although the optical element 100 preferably has a circular shape for ease of design and manufacture, other shapes are equally feasible, such as for instance other symmetrical shapes such as square or oblong shapes, or even optical elements 100 having an asymmetrical shape.

The zones 110, 120, 130, may be discontinuous in respect to each other. In the context of the present invention, this means that each zone exhibits a certain regular shape or pattern of shapes, e.g. facets, with the boundaries between the zones being characterized by a change in these shapes or patterns. This change in pattern may include a change in step height of the facets between zones, such that the surface of the optical element 100 at least partially defined by the facets 122, 132 may exhibit a stepped profile.

Where a zone is implemented by reflective facets such as TIR facets, these facets preferably are located in the light entry surface of the optical element 100 for reasons of optical efficiency. Similarly, where a zone is a refractive zone, e.g. implemented by refractive facets, the refractive elements are preferably located in the light exit surface of the optical element 100. This is for instance shown in FIGS. 10 and 11. It is however equally feasible to have the refractive elements located in the light entry surface of the optical element 100 and/or the reflective facets located in the light exit surface of the optical element 100.

In order to achieve the desired overlap between beamlet images within a zone, each region, e.g. facet, of the zone typically will have its major surface (also referred to as the deflection surface) under a predefined angle with the optical axis 105 such that the region implements a predefined deflection angle of the incident beamlet when the light source is placed at an intended distance from the optical element 100. For example, the beamlet deflection angle implemented by the respective regions, e.g. facets, of a zone may be systematically varied, e.g. in a stepwise fashion, in order to achieve the superposition of the beamlet images at the predefined distance from the optical element 100. In an embodiment, each region, e.g. facet, has a beamlet deflection angle that is a function of its radial position in the optical element 100, i.e. its radial distance from the optical axis 105. In other words, each region may have a systematically varied focal point along the optical axis 105, that is, the focal point of each region is displaced relative to the other regions in a particular zone, such that a different degree of beamlet blurring is introduced by each region due to the fact that the light source is positioned at a different distance to the respective focal points of the regions of the zone in order to achieve the desired color mixing within the light source image produced by the zone.

This will be further explained with the aid of FIG. 12, which schematically depicts a lighting device such as a spot light bulb in which a LED package 200 having a maximum dimension D2 is centered on the optical axis 105 at a predefined distance from an optical element 100 according to an embodiment of the present invention having a diameter D1. The diameter D1 of the optical element 100 can be larger than the maximum dimension D2 of the LED package 200. The maximum dimension D2 may coincide with a zone boundary of the optical element 100 as previously mentioned; here, by way of non-limiting example, the maximum dimension D2 coincides with the boundary between zones 120 and 130. Therefore, zones 110 and 120 may be refractive zones and zone 130 may be a reflective zone, e.g. a TIR zone although alternative implementations of these zones are equally feasible as previously explained.

As will be explained in more detail below, the number of zones and the radial dimensions of each zone is a matter of design choice, e.g. depending on the desired degree of collimation to be produced by the optical element 100, the required diameter of the optical element 100 and the maximum dimension of the light source, e.g. a LED package 200.

In FIG. 12, the light source is a LED package 200 having a maximum light generating surface dimension D2 of 1.5 mm, with the optical element 100 having a diameter D1 of 20 mm (i.e. its radius R=10 mm). The LED package is placed at a 5 mm distance from the optical element 100. In this example embodiment, the optical element 100 is designed to produce a beam spot having a beam angle of 24°.

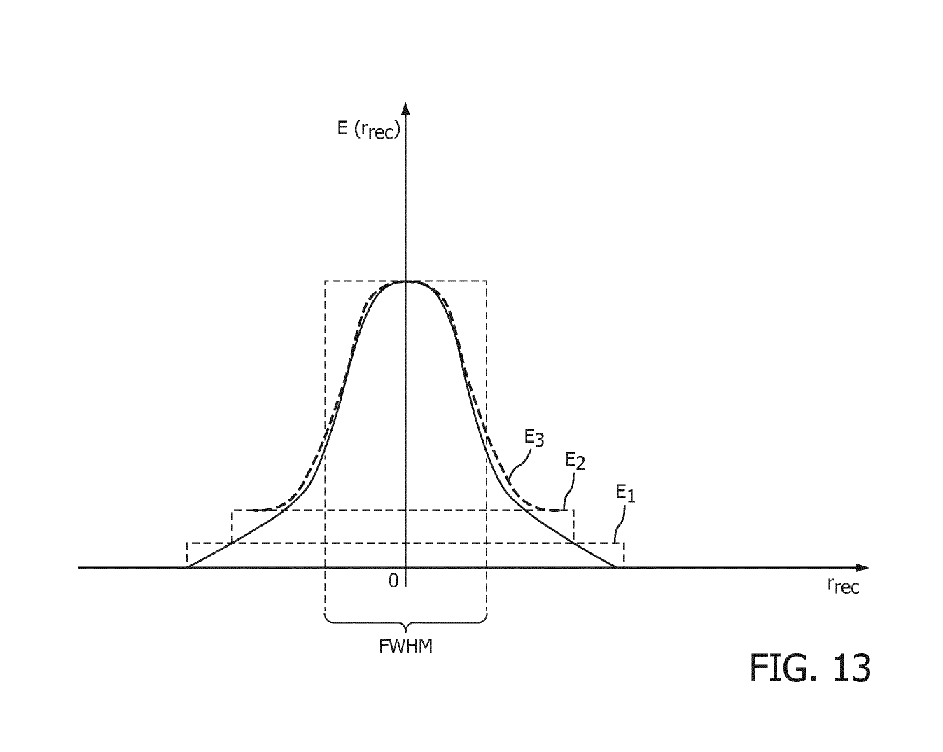

In an embodiment, the optical element 100 is designed to generate a Gaussian intensity profile, an example of which is schematically depicted in FIG. 13 by the solid line. This is by way of non-limiting example only as it has been previously explained that other types of light distributions, e.g. light distributions having a non-central intensity or contrast maximum are equally feasible. As previously explained, the target beam intensity profile, here a Gaussian profile, is typically partitioned in a number of slices, here three slices 310, 320 and 330, with the lower slices 310 and 320 approximating part of the light distribution by way of a uniform or constant illuminance and the third slice 330 approximating the upper part of the Gaussian profile by way of a Gaussian illuminance. The lower slice 310 corresponds to the target illuminance produced by first zone 110, the intermediate slice 320 corresponds to the target illuminance produced by intermediate zone 120 and the upper slice 330 corresponds to the target illuminance produced by outer zone 120. In other words, zones with increasing radial position typically produce an image with reducing beam angle to reflect the smaller beamlet image size produced at the target location for which a smaller sweep across the beamlet deflection angles is required to achieve image blurring.

The beam deflection range is reduced for zones located at larger radial position to generate the Gaussian beam intensity profile as each consecutive zone is projected exactly on top of the previous zone at a target distance from the lens 100 with its center located at the optical axis. For the constant illuminance zones, this requires the luminous flux as a function of radial position rrec to obey the following equation:

dΦ(r_{rec})=2πr_{rec}dr_{rec}

For the Gaussian illuminance zones, the luminous flux as a function of radial position r_{rec}, must obey the following equation:

$$d Φ ( {r}_{rec} ) = 2 π {r}_{rec} {E}_{i} {e}^{- \frac{{r}_{rec}^{2}}{2 {σ}^{2}}} {dr}_{rec}$$

wherein Eᵢ is the illuminance of the i^{th} zone of the optical element 100.

The superposition of the various illuminances by the respective zones 110, 120, 130 at the target distance from the optical element 100 can be seen to approximate a Gaussian profile by the following equation:

$$E ( {r}_{rec} ) = {E}_{0} {e}^{- \frac{{r}_{rec}^{2}}{2 {σ}^{2}}} \approx {\sum }_{i = 1}^{3} {E}_{i} ( {r}_{rec} ) = {E}_{1} + {E}_{2} + {E}_{3} {e}^{- \frac{{r}_{rec}^{2}}{2 {σ}^{2}}}$$

wherein E₁, E₂ are constant illuminances generated by zones 110 and 120 respectively,

$${E}_{3} {e}^{- \frac{{r}_{rec}^{2}}{2 {σ}^{2}}}$$

is the Gaussian illuminance produced by zone 130 and

$${E}_{0} {e}^{- \frac{{r}_{rec}^{2}}{2 {σ}^{2}}}$$

is the target Gaussian illuminance.

In order to achieve the desired illuminances for each zone, the flux as a function of radial position may be calculated from the following equations:

$$\frac{d {Φ}_{c} ( {r}_{rec} )}{{dr}_{rec}} = 2 π {E}_{c} . {r}_{rec}$$

wherein Φ_{c} is the flux and E_{c} is the luminance of a constant luminance zone;

$$\frac{d {Φ}_{g} ( {r}_{rec} )}{{dr}_{rec}} = 2 π {E}_{g} . {r}_{rec} {e}^{- \frac{{r}_{rec}^{2}}{2 {σ}^{2}}}$$

wherein Φ_{g} is the flux and E_{g} is the luminance of a Gaussian luminance zone.

The flux as a function of radial image position for the overall superimposed image created by the optical element 100 thus approximates the flux of a Gaussian luminance as can be seen by the following equation:

$$\frac{d {Φ}_{gauss} ( {r}_{rec} )}{{dr}_{rec}} = 2 π {E}_{0} . {r}_{rec} {e}^{\frac{- {r}_{rec}^{2}}{2 {σ}^{2}}} \approx {\sum }_{z = 1}^{3} \frac{d {Φ}_{z} ( {r}_{rec} )}{{dr}_{rec}} = 2 π ( {E}_{1} + {E}_{2} + {E}_{3} {e}^{\frac{- {r}_{rec}^{2}}{2 {σ}^{2}}} ) . {r}_{rec}$$

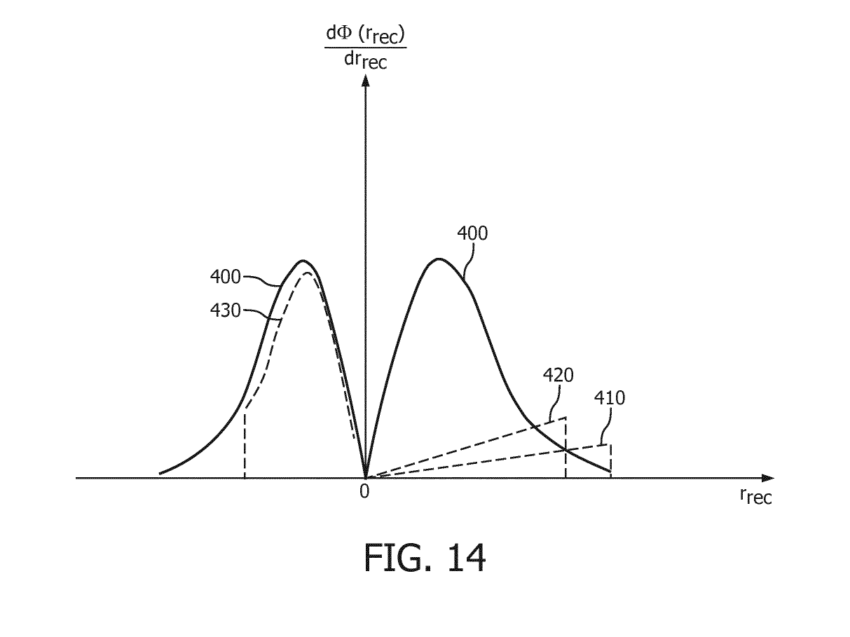

This is schematically visualized in FIG. 14, which depicts the respective target flux distributions 410, 420, 430 for zones 110, 120 and 130 respectively, with the overall target Gaussian illuminance depicted as a solid line 400. Two curves are shown reflecting the positive extraction angles of zones 110, 120 and the negative extraction angles of zone 130. The increase in target flux with increasing radial position for target flux distributions 410, 420 can be understood from the increased annulus surface area with increasing radial position, which therefore requires an increased flux to maintain constant illuminance over the full width of a particular constant illuminance zone.

It is reiterated that the slicing of the target illuminance is not limited to horizontal slicing; other slicing strategies generating slices that are axially symmetrical, e.g. triangular shaped slicing, are equally feasible although it will be understood that horizontal slicing is preferable due to its suitability to produce light distributions closely approximating desired target illuminance, e.g Gaussian distributions.

In this manner, the various zones of the optical element 100 may be selected and their target flux distributions determined as explained above. Subsequently, the incident flux distribution as produced by the light source 200 needs to be matched to the target flux distributions to be produced by the optical element 100. This typically requires the generation of a transfer function for this purpose in order to connect a radial optical element position r to image position r_{rec}.

For a point light source, an infinite number of such transfer functions exist, such that in such a hypothetical scenario, attributing optical element zones to a target flux distribution can be chosen in a random fashion. However, for extended light sources, e.g. a LED package, the zone boundaries of a zone of the optical element 100 must be chosen such that the zone can accommodate the cone angle corresponding to that zone. Therefore, the zone should be sufficiently wide to accommodate the cone angle. Preferably, the cone angle divided by two should not exceed the maximum extraction angle of the zone. More preferably, the extraction angle implemented by an optical element region is exactly equal to half its cone angle, as this causes the edge of the source image to be projected onto the optical axis 105 at the target location beyond the optical element 100, e.g. a location in the far field. This image edge would overlap with the image center extracted at 0°, i.e. parallel to the optical axis 105. For example, for a cone angle (or “image size” or “beamlet width”) of 30°, to achieve complete image blurring, this minimally requires a zone region, e.g. facet, with a beam extraction angle of about 30/2=15° for the image edge of one beamlet image to be projected on top of the image center of another image in the target location.

In order to calculate the extraction angle in a single zone, an average image size for that zone may be chosen. So for example, in the example the cone angles at the zone boundaries are, as a function of radial distance R shown in Table I:

TABLE I

| R [mm] | Cone angle [°] |
|---|---|
| 0 | 33 |
| 3 | 25 |
| 5 | 17 |
| 10 | 7 |

Based on the chosen widths of the various zones and the cone angle ranges delimiting each zone, the minimal beam sweeping within a zone can be calculated as explained above.

It is reiterated that the cone angle oa is determined by the light source size and optical element-source distance according to:

$$oa = {tan}^{- 1} ( \frac{{r}_{s} + r}{d} ) + {tan}^{- 1} ( \frac{{r}_{s} - r}{d} ) for r \leq {r}_{s} ;$$

$$oa = {tan}^{- 1} ( \frac{{r}_{s} + r}{d} ) - {tan}^{- 1} ( \frac{r - {r}_{s}}{d} ) for r > {r}_{s}$$

This also demonstrates why the inner zones are assigned to the lower (widest) partitions of the target illuminance as such zones need to cover a larger range of extraction angles due to the larger associated cone angles, which therefore requires a wider image or beam profile to achieve the desired image blurring. It is noted that the extraction angles are assigned to the central ray of a cone such that the area illuminated by an optical element portion having the assigned extraction angle extends beyond the maximum extraction angle by half a cone angle.

The definition of suitable transfer functions is a routine exercise for the skilled person. For example, a suitable transfer function r_{rec}(r) for converting an incident Lambertian illuminance into a constant illuminance output can be derived as follows. In general, the following equation holds:

$$2 π {E}_{c} {r}_{rec} \times {dr}_{rec} = d {Φ}_{c} ( {r}_{rec} ) = d {Φ}_{lamb} ( r ) = \frac{2 r}{{d}^{2}} {( \frac{{r}^{2}}{{d}^{2}} + 1 )}^{- 2} \times dr ,$$

with Φ_{lamb}(r) the incident Lambertian flux distribution. From this equation, the transfer function r_{rec}(r) can be derived as follows:

$${r}_{rec} \times {dr}_{rec} = \frac{1}{2 π {E}_{c}} . \frac{2 r}{{d}^{2}} {( \frac{{r}^{2}}{{d}^{2}} + 1 )}^{- 2} \times dr$$

in forward direction; and

$$- {r}_{rec} \times {dr}_{rec} = \frac{1}{2 π {E}_{c}} . \frac{2 r}{{d}^{2}} {( \frac{{r}^{2}}{{d}^{2}} + 1 )}^{- 2} \times dr$$

in backward direction.

The transfer function for converting an incident Lambertian illuminance into a Gaussian illuminance output can be derived as follows. In general, the following equation holds:

$$2 π {r}_{rec} {E}_{g} {e}^{\frac{- {r}_{rec}^{2}}{2 {σ}^{2}}} \times {dr}_{rec} = d {Φ}_{g} ( {r}_{rec} ) = d {Φ}_{lamb} ( r ) = \frac{2 r}{{d}^{2}} {( \frac{{r}^{2}}{{d}^{2}} + 1 )}^{- 2} \times dr .$$

From this equation, the transfer function r_{rec}(r) can be derived as follows:

$$2 π {r}_{rec} {E}_{g} {e}^{\frac{- {r}_{rec}^{2}}{2 {σ}^{2}}} \times {dr}_{rec} = \frac{2 r}{{d}^{2}} {( \frac{{r}^{2}}{{d}^{2}} + 1 )}^{- 2} \times dr$$

in forward direction; and

$$- 2 π {r}_{rec} {E}_{g} {e}^{\frac{- {r}_{rec}^{2}}{2 {σ}^{2}}} \times {dr}_{rec} = \frac{2 r}{{d}^{2}} {( \frac{{r}^{2}}{{d}^{2}} + 1 )}^{- 2} \times dr$$

in backward direction.

In this context, the term ‘forward direction’ within a zone refers to moving in the positive ‘r’-direction over the Lambertian distribution and matching this movement by moving in the positive direction over the target distribution. The term ‘backward direction’ within a zone refers to moving in the positive ‘r’-direction over the Lambertian distribution and matching this movement by moving in the negative direction over the target distribution.

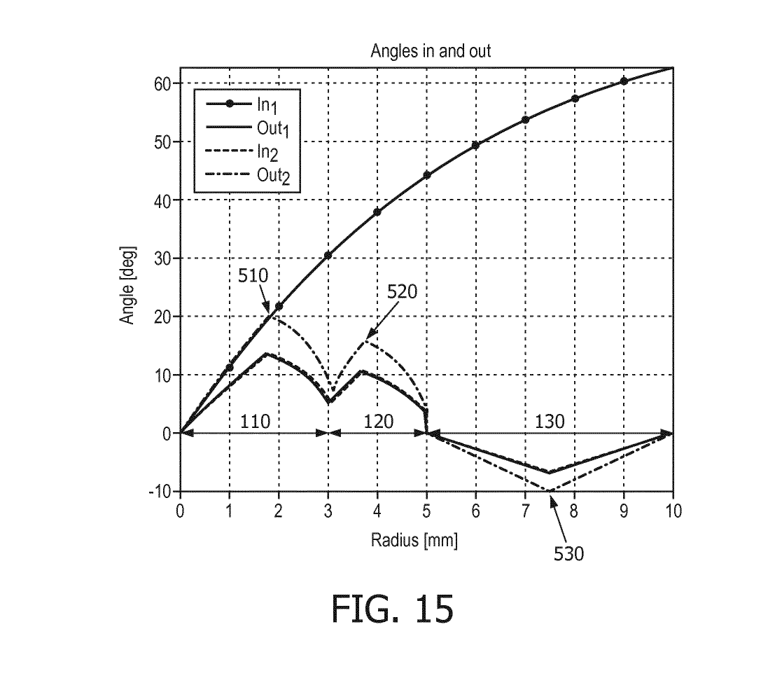

In the example embodiment of the spot generation with the desired 24° beam angle, i.e. a FWHM at 24° in the Gaussian profile, a transfer function as depicted in the graph of FIG. 15 may be obtained in this manner. FIG. 15 is a transfer function of an optical element 100 in which all zone regions are located in the light exit surface of the optical element 100. This transfer function may be implemented using the depicted beam extraction angles, which depicts the transfer function as a function of radial position for incoming Lambertian rays and outgoing rays at the collecting (designated by the suffix ‘1’) and extracting (designated by the suffix ‘2’) interfaces of the optical element 100 in order to obtain the desired beam spot, i.e. obtain the target distribution for the optical element 100.

In this example, the beam extraction angles in central zone 110 range from 0° to 20°, the beam extraction angles in faceted zone 120 range from 0° to 16° and the beam extraction angles in faceted TIR zone 130 range from 0° to 10°. This ensures that a Gaussian beam profile with FWHM of 24° is generated for the given light source size and source optical element distance by the aforementioned superposition of the constant illuminance profiles generated by zones 110 and 120, and the Gaussian luminance profile produced by zone 130.

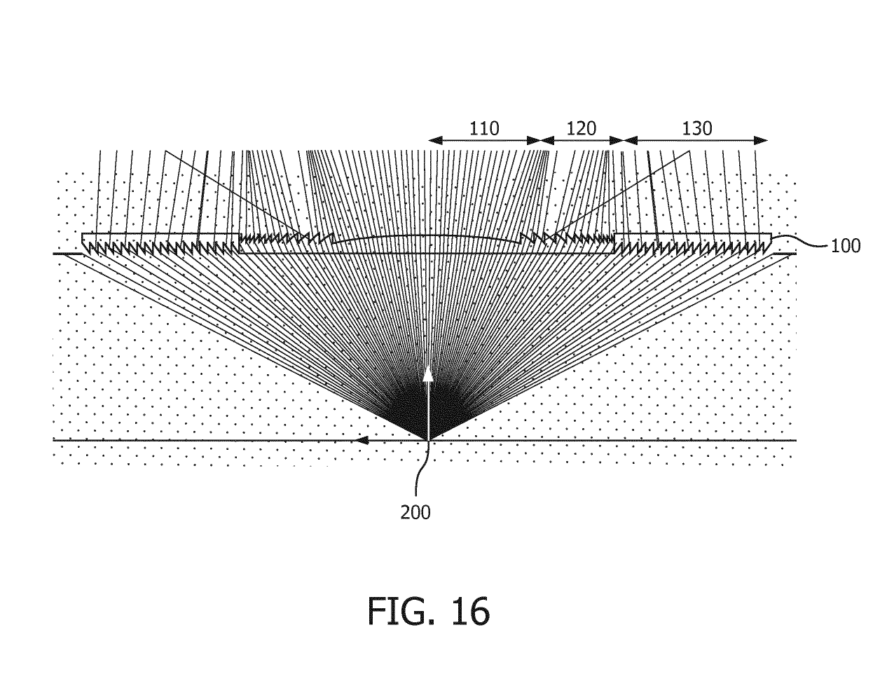

The light distribution generated by a lighting device according to an example embodiment is schematically depicted in FIG. 16, which demonstrates that zone 130 redirects its luminous output, i.e. its superimposed image, towards the superimposed image generated by the first zone 110.

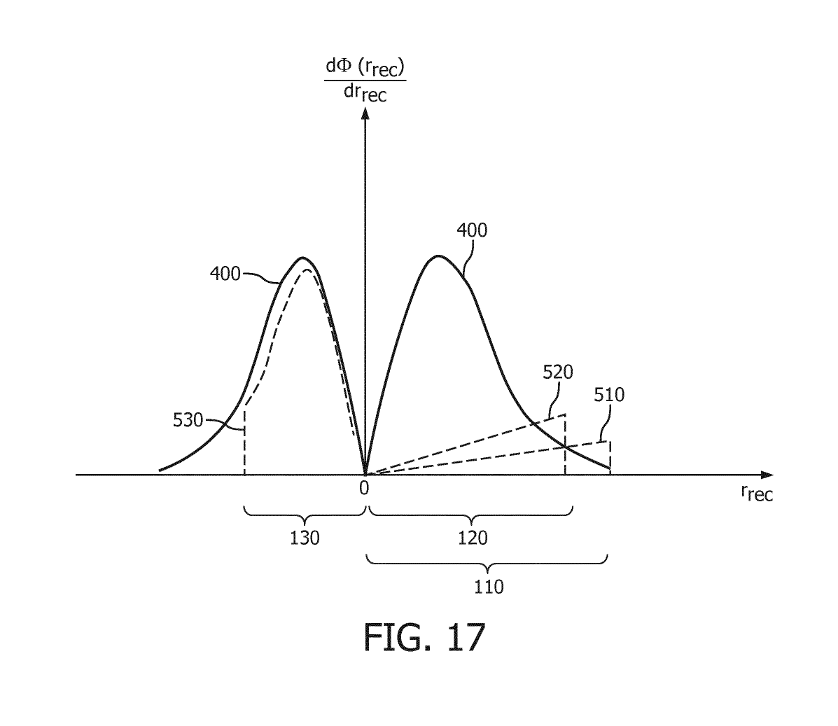

FIG. 17 schematically depicts the flux profiles of FIG. 14 translated into the extraction angle ranges of zones 110, 120 and 130 respectively, with zone 110 having a maximum extraction angle 510 of 20°, zone 120 having a maximum extraction angle 520 of 16° and zone 30 having a maximum extraction angle 530 of −10°. The maximum extraction angles are also highlighted in FIG. 15. Due to the rotational symmetry of the example optical element 100, in particular for the constant luminance zones and/or the refractive zones of the example optical element 100, the sign of the extraction angles is immaterial. However, negative extraction angles are preferred for TIR facets as they yield higher extraction efficiency than positive extraction angles; for incident angles >45° and extraction angles >0° rays are more likely to totally internally reflect inside the optical element 100, thus reducing optical efficiency.

It is reiterated that in order to create a uniform beam spot from an extended light source, the number of zones within which a deflection angle is swept can be chosen arbitrarily, although a relatively large number of zones is preferable as it makes the optical element design more robust against changes in the required optical element diameter; (partial) removal of an outermost zone or optical element rim does not significantly affect the target output distribution of the optical element, e.g. a Gaussian distribution. In other words, a larger number of zones provides a better approximation of the desired target distribution and the removal of (part of) a single zone does not significantly affect the approximation. In the above example, the deflection angle is chosen to be a continuous function of radial position, but this is not mandatory and can be modified arbitrarily. Alternatively, a zone may include an inner facet, an outer facet and an intermediate facet in between the inner facet and outer facet, wherein the respective angles of the deflection surface of the facets increase from the inner facet to the intermediate facet, and decrease from the intermediate facet to the outer facet or vice versa.

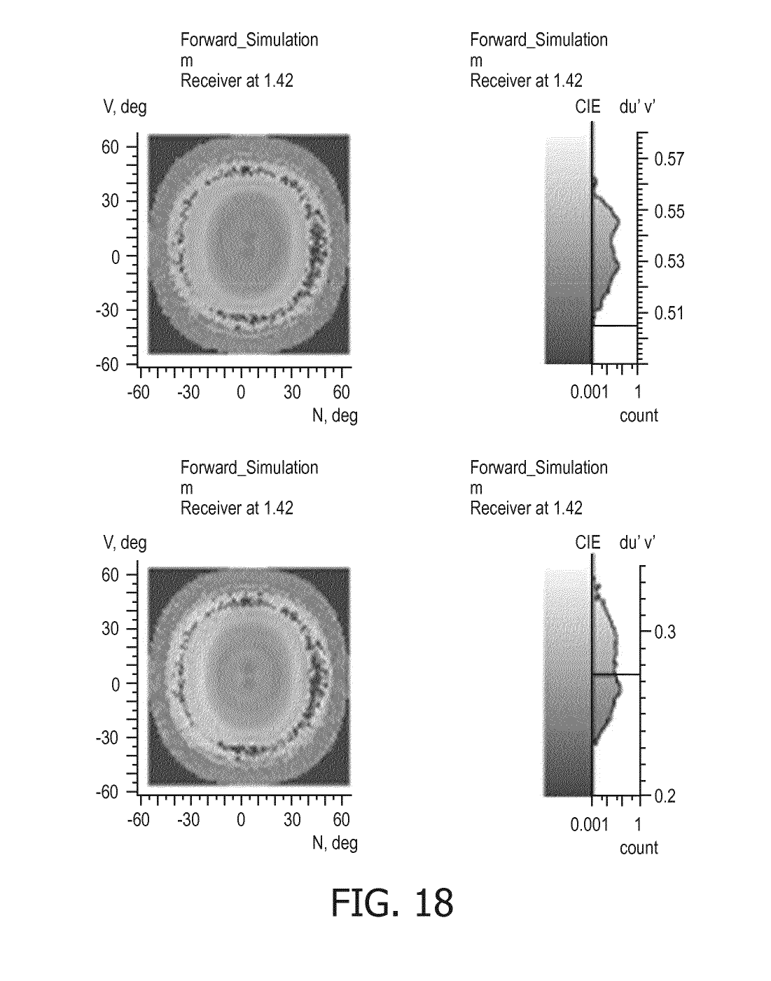

As previously explained, the outer zones will generate an image having a smaller beam angle than the image generated by an inner zone, such that the outer zone image can be superimposed in its entirety on the inner zone image in order to build up the desired illumination profile as a consequence of the larger cone angles associated with the inner zones of the optical element 100. FIG. 18 shows CIE v′ (top) and CIE u′ (bottom) images of a Nichia 3030 LED package (maximum diameter 1.5 mm) as manufactured by the Nichia corporation generated by a circular optical element 100 having a 10 mm radius and the zones 110, 120, 130 as per Table I with the aforementioned beam deflection angle sweep values positioned at 5 mm from the LED source and the spectral composition of these images. The improved homogeneity of the beam spot in terms of colour separation for both the CIE u′ and CIE v′ images compared to the images generated by the collimating TIR Fresnel lens depicted in FIGS. 8 and 9 is immediately apparent from the spectral information. Also noticeable is the fact that no die image can be observed in the images generated by the circular optical element 100, due to the beamlet image blurring implemented by the various zones of the optical element 100. What remains is some modest color contrast between cold white and warm white at the edge of the collimated beam formed by the optical element 100, but this is well within acceptable limits.

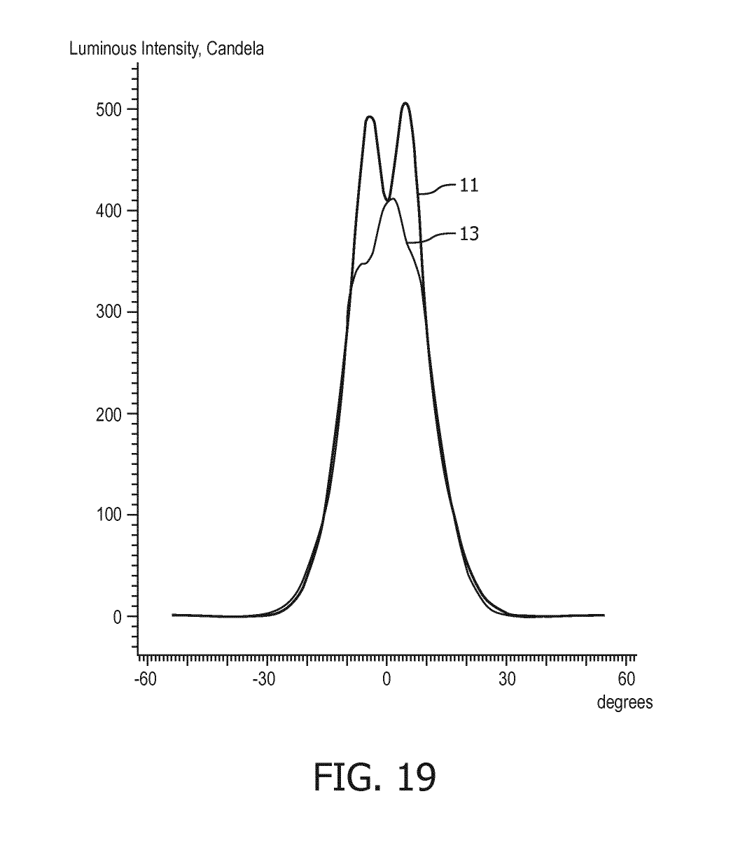

FIG. 19 depicts the simulated luminous intensity distribution 11 of the CIE v′ image and the luminous intensity distribution 13 of the CIE u′ image in FIG. 18. This clearly demonstrates that a highly uniform beam is produced in terms of color separation, i.e. a beam exhibiting substantially reduced color separation compared to state of the art collimators. Hence, excellent color mixing is achieved combined with effective collimation by a single beamlet deflection step.

A circular shape of the optical element 100 facilitates ease of manufacturing. For instance, the optical element 100 may be manufactured in a one-step process by diamond milling for instance. The optical element 100 may be made of any suitable material, e.g. glass or an optical grade polymer such as polycarbonate, poly (methylmethacrylate), polyethylene terephtalate, and so on. Other optical element shapes are equally feasible however as previously explained.

At this point it is furthermore noted that the extraction angles of the various zones of the optical element 100 may be implemented in any suitable manner, e.g. by a single extraction surface under a predefined angle with the incident rays, e.g. a light entry surface portion or a light exit surface portion of the optical element 100, or by the combination of such a light entry surface portion and light exit surface portion.

The lighting device according to embodiments of the present invention may be a spot light bulb but is not limited thereto. The lighting device may be integrated in a luminaire, such as a spot light holder, e.g. a ceiling- or wall-mounted luminaire, a luminaire for automotive applications, and so on. Alternatively, the lighting device may be integrated in an electrical device arranged to illuminate a work surface, e.g. an extraction fan over a shower cubicle, a cooker hood, and so on.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A lighting device comprising an optical element and a light source having a light emission surface with a maximum dimension (D2) placed on the optical axis of the optical element and arranged to direct its luminous output towards the optical element, wherein the optical element is arranged to create a beam having an increased degree of collimat ion from the luminance distribution of the light source, the optical element comprising:
an inner zone centered on said optical axis, the inner zone having a plurality of inner zone regions for generating a first plurality of partially overlapping images of said luminance distribution at a defined finite distance from the optical element, said the first plurality of partially overlapping images defining a first beam portion having a first width at the defined distance; and
an outer zone around said inner zone, the outer zone having a second plurality of outer zone regions for generating a second plurality of partially overlapping images of said luminance distribution at the defined finite distance, the second plurality of partially overlapping images defining a second beam portion having a second width smaller than the first width at the defined distance, the second beam portion being superimposed on the first beam portion at the defined finite distance,
and wherein the light source is positioned at a distance from the optical element such that, for each of said zones regions, its extraction angle assigned to the central ray of a cone of said luminous output having its apex coinciding with said zone region and its base centered at said maximum dimension does not exceed half the cone angle (oa) of said cone.

2. The lighting device of claim 1, wherein the inner zone is arranged to create a first beam portion having a constant luminance across the first width from a Lambertian luminance distribution, wherein the first width optionally defines the beam width of the beam.

3. The lighting device of claim 2, wherein the outer zone is arranged to create a second beam portion having a variable luminance across the second width from the Lambertian luminance distribution.

4. The lighting device of claim 1, wherein the outer zone regions comprise a plurality of reflecting facets, the facets combining to generate the second plurality of partially overlapping images.

5. The lighting device of claim 4, wherein the outer zone is a total internal reflection zone.

6. The lighting device of claim 1, wherein the inner zone is a refractive zone.

7. The lighting device of claim 1, wherein the inner zone regions and/or the outer zone regions have different focal points on the optical axis.

8. The lighting device of claim 7, wherein the focal points are a function of the radial position of the zone regions.

9. The lighting device of claim 1, wherein at least some of the inner zone regions are facets.

10. The lighting device of claim 1, wherein the optical element further comprises at least one intermediate zone in between the inner zone and the outer zone, the at least one intermediate zone comprising a plurality of further zone regions for generating a further plurality of partially overlapping images of said illumination pattern at the defined finite distance from the optical element, the further plurality of partially overlapping images defining a further beam portion having a further width at the defined finite distance, the further width being smaller than the width of each zone at a smaller radial position of the optical element and larger than the width of each zone at a larger radial position of the optical element, the further fbeam portion being superimposed on the first beam portion at the defined finite distance.

11. The lighting device of claim 1, the optical element having a major surface comprising a stepped profile in which each step delineates one of said respective zones.

12. (canceled)

13. The lighting device of claim 1, wherein the optical element has a diameter (D1) that is larger than a maximum dimension (D2) of a light emission surface of the light source.

14. The lighting device of claim 1, wherein the light source comprises a light emitting diode package including at least one light emitting diode and a phosphor for converting a light wavelength generated by the at least one light emitting diode.

15. A luminaire comprising the lighting device of claim 1.
